(19) United States
(12) Patent Application Publication
(10) Pub. No.: US 2019/0235521 A1
(43) Pub. Date: Aug. 1, 2019

(54) SYSTEM AND METHOD FOR END-TO-END AUTONOMOUS VEHICLE VALIDATION

(71) Applicant: GM GLOBAL TECHNOLOGY OPERATIONS LLC, Detroit, MI (US)

(72) Inventors: Upali P. Mudalige, Oakland Township, MI (US); Wei Tong, Troy, MI (US); Praveen Palanisamy, Sterling Heights, MI (US)

(73) Assignee: GM GLOBAL TECHNOLOGY OPERATIONS LLC, Detroit, MI (US)

(21) Appl. No.: 15/886,129

(22) Filed: Feb. 1, 2018

(51) Int. Cl. G05D 1/02; G05D 1/00

(52) U.S. Cl. CPC G05D 1/0251; G05D 1/0274; G05D 1/0088; G05D 1/0248

(57) ABSTRACT

Systems and method are provided for evaluating control features of an autonomous vehicle for development or validation purposes. A real-world sensor data set is generated by an autonomous vehicle having sensors. A sensing and perception module generates perturbations of the real-world sensor data set. A generator module generates a 3-dimensional object data set from the real-world sensor data set. A planning and behavior module generates perturbations of the 3-dimensional object data set. A testing module tests a control feature such as an algorithm or software using the 3-dimensional object data set. A control module executes command outputs from the control feature for evaluation.

### TECHNICAL FIELD

The present disclosure generally relates to automotive vehicles, and more particularly relates to systems and methods for developing and validating autonomous vehicle operation using real-world and virtual data sources.

### BACKGROUND

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, maps, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

To achieve high level automation, vehicles are often equipped with an increasing number of different types of devices for analyzing the environment around the vehicle, such as, for example, cameras or other imaging devices capturing imagery of the environment, radar or other ranging devices for surveying or detecting features within the environment, and the like. In addition, a number of actuators are used to control the vehicle in response to numerous programs and algorithms. Evaluating and validating autonomous vehicle control and operation during product development involves a high level of complexity.

Accordingly, it is desirable to conduct validation in a reasonable time frame to bring products to the marketplace. Other desirable features and characteristics of the present invention will become apparent from the subsequent detailed description and the appended claims, taken in conjunction with the accompanying drawings and the foregoing technical field and background.

### SUMMARY

Systems and methods are provided for developing and validating an autonomous vehicle. In one embodiment, a method includes collecting, by an autonomous vehicle having a sensor system and actuators, a real-world sensor data set. A fusion module of a computer system fuses the real-world data from multiple sensors and maps. A converter module converts the fused real-world sensor data set to a common representation data set form. A perturbation (fuzzing) module generates perturbations from the converted real-world sensor data set. A generator module generates a 3-dimensional object data set from the common representation data set from of the real-world sensor data set. The 3-dimensional object data set is used to evaluate planning, behavior, decision making and control features such as of algorithms and software of the autonomous vehicle.

In another embodiment, a method includes collecting, by an autonomous vehicle having a sensor system and actuators, a real-world sensor data set. A generator module generates a 3-dimensional object data set from the real-world sensor data set. A perturbation (fuzzing) module of a planning and behavior module generates perturbations of the 3-dimensional data set to create additional traffic scenarios. For evaluation, the planning and behavior module executes a control feature such as an algorithm or software by using the 3-dimensional database including the perturbations in executing the control feature.

In another embodiment, a system uses a real-world sensor data set generated by an autonomous vehicle having sensors. A sensing and perception module generates perturbations of the real-world sensor data set. A generator module generates a 3-dimensional object data set from the real-world sensor data set. A planning and behavior module generates perturbations of the 3-dimensional object data set. A testing module evaluates a control feature such as an algorithm or software using the 3-dimensional object data set. A control module executes command outputs from the control feature for the evaluation.

In some embodiments, a system uses a synthetic data set generated by high-fidelity sensor models using a virtual environment. A virtual scene generator module generates a 3-dimensional object data set from the virtual sensors to create large number of traffic scenarios, road and environmental conditions. Such object data set is used in a perturbation module of a planning and behavior module to generate perturbations of the 3-dimensional data set to create additional traffic scenarios. For evaluation, the planning and behavior module executes a control feature such as an algorithm or software by using the 3-dimensional database including the perturbations in executing the control feature.

In another embodiment, a method includes generating a virtual sensor (synthetic), data set by a sensor model emulator, fusing the virtual sensor data set in a fusion module, converting the fused virtual sensor data set to the common representation data set form, such as a voxel data set, by a converter module, and generating, by a generator module, the 3-dimensional object data set from the common representation data set form of the virtual sensor data set.

In another embodiment, a method includes converting to a common representation data set form by converting the real-world sensor data set to a voxel data set.

In another embodiment, a method includes storing the 3-dimensional data set in a test database, and generating perturbations of the 3-dimensional data set to create traffic scenarios, such as adding additional and new vehicles, objects and other entities to the traffic scenarios.

In another embodiment, a method includes evaluating, by a planning and behavior module, an algorithm by using the 3-dimensional database in executing the algorithm.

In another embodiment, a method includes executing command outputs from the control feature in a control module that simulates the autonomous vehicle, such as one that includes the actuators of the autonomous vehicle, to evaluate their operation. An evaluation of the command outputs may also be carried out by an evaluation engine in relation to scoring metrics.

In another embodiment, a method includes generating second perturbations from the converted real-world sensor data set.

In another embodiment, a system's control module includes actuators of the autonomous vehicle that are responsive to the command outputs.

In another embodiment, a system includes a sensor and perception module that fuses by a fusion module of a computer system, the real-world sensor data set. A converter module converts the fused real-world sensor data set to a common representation data set form, prior to generating the 3-dimensional object data set.

In another embodiment, a system includes a sensor model emulator configured to generate a virtual sensor data set (synthetic data set), from a sensor model. The planning and behavior module is configured to evaluate, in an evaluation engine, the command outputs for performance in relation to scoring metrics. The real-world sensor data set may include data from infrastructure based sensors and mobile platform based sensors.

In another embodiment, a system includes at least one processor configured to process data at frame-rates in excess of thirty frames per second, sufficient to evaluate at least, millions of vehicle miles for development and validation.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle for collecting data, in accordance with various embodiments;

FIG. 2 is a functional block diagram illustrating a system for autonomous vehicle development and validation having a sensing and perception module and a planning and behavior module, in accordance with various embodiments;

FIG. 3 is a schematic block diagram of the system of FIG. 2, in accordance with various embodiments;

FIG. 4 is functional block diagram of the sensing and perception module of the system of FIG. 3, in accordance with various embodiments;

FIG. 5 is functional block diagram of the planning and behavior module of the system of FIG. 3, in accordance with various embodiments; and

FIG. 6 is a flowchart illustrating a process for autonomous vehicle development and validation, in accordance with one or more exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, imaging, ranging, synchronization, calibration, control systems, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

In one or more exemplary embodiments related to autonomous vehicles and as described herein, systems and methods generally include the collection of data from real world and/or simulated sources. Data may be collected from numerous autonomous vehicles such as a fleet of vehicles, may be collected from infrastructure sources, including sensors and wireless devices, and may be collected from other mobile platforms such as air based vehicles. Data pertaining to rear situations and/or those difficult to collect in the real world are synthetically generated in a simulated environment with high-fidelity sensor models. These sources enhance the collection of specific scenes that may be rare or challenging to collect from a road vehicle. The data may include information on a vehicle's environment such as traffic signs/signals, road geometry, weather, and other sources. The data may include information on operation of the vehicle such as operation of actuators that control the vehicle's functions. The data may also include object properties such as location, size, type, speed, acceleration, heading, trajectory, surface reflectivity, material properties, and other details. In addition, the data may include event details such as lane changes, velocity changes, direction changes, stops, and others. Perturbations are generated to expand the database size, such as through the use of fuzzing. Perturbation may be conducted at various stages. The collected data is converted to a common representation format, and may be further manipulated into a preferred format for further use. Algorithms and software may be evaluated referencing the database for scenarios that may entail customized behaviors. A very large number of scenarios may be used to evaluate algorithms. For example, thousands of simulations may be evaluated and the equivalent of billions of vehicle miles may be simulated. Algorithm/software performance is evaluated relative to metrics and also in the control of an autonomous vehicle. Algorithms/software may be evaluated and improved as part of developmental activity, and developed algorithms/software may be validated using the systems and methods described herein.

As can be appreciated, the subject matter disclosed herein provides certain enhanced features and functionality for autonomous vehicle development and validation. To this end, an autonomous vehicle and autonomous vehicle development and validation systems and methods may be modified, enhanced, or otherwise supplemented to provide the additional features described in more detail below.

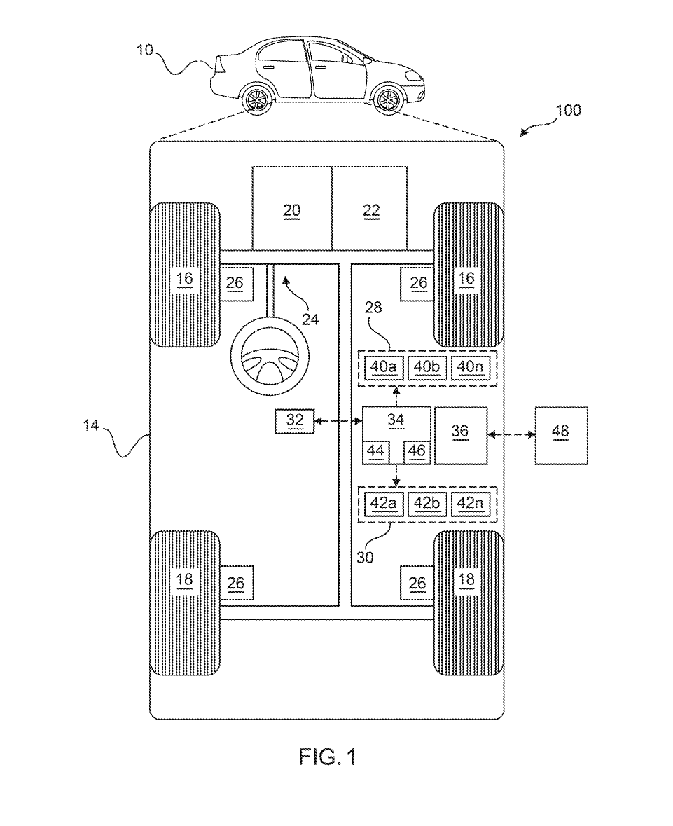

Referring now to FIG. 1, an exemplary autonomous vehicle 10 includes a control system 100 that determines a motion plan for autonomously operating a vehicle 10 along a route in a manner that accounts for objects or obstacles detected by onboard sensors 28, 40, as described in greater detail below. In this regard, a control module onboard the autonomous vehicle 10 uses different types of onboard sensors 28, 40, and enables data from those different types of onboard sensors 28, 40 to be spatially or otherwise associated with one another for object detection, object classification, and the resulting autonomous operation of the vehicle 10. Aspects of the vehicle 10, such as control features including algorithms and software, may be developed and validated using the systems and methods described herein. Those systems and methods use real-world data collected from a fleet of autonomous vehicles, such as the vehicle 10. Accordingly, in some embodiments the vehicle 10 may be an integral part of those systems and processes and therefore, vehicle 10 is described in detail herein.

As depicted in FIG. 1, the vehicle 10 generally includes a chassis, a body 14, and front and rear wheels 16, 18 rotationally coupled to the chassis near a respective corner of the body 14. The body 14 is arranged on the chassis and substantially encloses components of the vehicle 10, and the body 14 and the chassis may jointly form a frame.

The vehicle 10 is an autonomous vehicle and a control system 100 is incorporated into the autonomous vehicle 10. The vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16, 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16, 18. The brake system 26 may, in various embodiments, include friction brakes, brake by wire, a regenerative braking system such as an electric machine, and/or other appropriate braking systems. The steering system 24 influences a position of the of the vehicle wheels 16, 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n may include, but are not limited to, radars, lidars, global positioning systems, optical cameras, thermal cameras, ultrasonic sensors, steering angle sensors, throttle sensors, wheel speed sensors, temperature sensors, and/or other sensors, including vehicle-to-vehicle, vehicle-to-human, and vehicle-to-infrastructure communication devices. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

The data storage device 32 stores data for use in automatically controlling the autonomous vehicle 10. In various embodiments, the data storage device 32 stores defined maps of the navigable environment. In various embodiments, the defined maps may be predefined by and obtained from a remote system. For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system. The data storage device 32 may also store information collected during operation of the vehicle 10 including data from the sensors 28, 40 and from operation of the actuators 30, 42 and may be part of the vehicle's logging system. As such, the data represents real-world information of actual scenes, objects, functions and operations.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a microprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the control system 100 (e.g., in data storage element 46) and, when executed by the processor 44, cause the processor 44 to detect or identify a stationary or moving condition of the vehicle 10 based on the output data from one or more vehicle sensors 40 (e.g., a speed sensor, a positioning sensor, or the like), obtain data captured or generated from imaging and ranging devices. Thereafter, the processor 44 may establish correlations and transformations between the data sets or the vehicle reference frame to assign attributes from one data set to another data set, and thereby improve object detection, object classification, object prediction, and the like. The resulting objects and their classification and predicted behavior influences the travel plans for autonomously operating the vehicle 10, which, in turn, influences commands generated or otherwise provided by the processor 44 to control actuators 42. As the data is captured or generated it is logged and may be stored in the data storage device 32, or in other devices of the vehicle 10.

The control system 100 synthesizes and processes sensor data and predicts the presence, location, classification, and/or path of objects and features of the environment of the vehicle 10. The control system 100 processes sensor data along with other data to determine a position (e.g., a local position relative to a map, an exact position relative to lane of a road, vehicle heading, velocity, etc.) of the vehicle 10 relative to the environment. The control system 100 processes sensor data along with other data to determine a path for the vehicle 10 to follow. The vehicle control system 100 generates control signals for controlling the vehicle 10 according to the determined path.

Still referring to FIG. 1, in exemplary embodiments, the communication system 36 is configured to wirelessly communicate information to and from other entities with communication device(s) 48, such as but not limited to, other vehicles (“V2V” communication,) infrastructure (“V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards. The communication system 36 may be used to communicate data logged in the data storage device to the system or systems described herein for use of real-world data in development and validation activities.

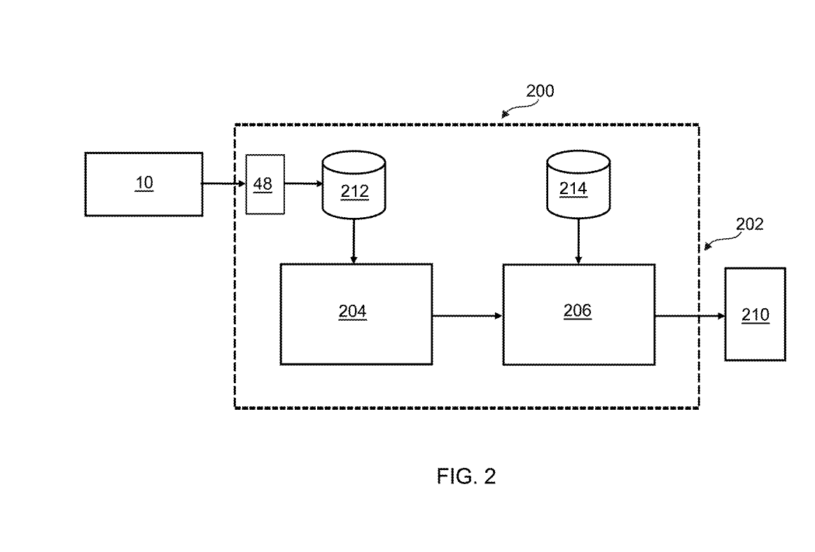

Referring now to FIG. 2, in accordance with various embodiments, a validation system 200 is associated with the representative autonomous vehicle 10, which may be but one of numerous autonomous vehicles such as a fleet of autonomous vehicles. The validation system 200 is effected through a computer(s) 202 that includes one or more computers configured to execute the methods, processes, and/or operations hereof. The computer(s) 202 generally includes a communication structure, which communicates information between systems and devices, such as a processor, and other systems and devices. Computer(s) 202 may include input/output devices, such as human interface devices, and other devices to provide information to and from the computer(s) 202. In the current embodiment the computer(s) 202 includes a communication device comprising a remote system of the other entities with communication device(s) 48 described above, for communicating with the communication system 36 of the vehicle 10. The computer(s) 202 performs operations via one or more processors executing instructions stored in memory. The memory may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the computer(s) 202. In various embodiments, the computer(s) 202 is configured to implement a vehicle development and validation system as discussed in detail below. The computer(s) 202 is configured with an operating system, application software and modules as defined above. In general, the modules include a sensing and perception module 204 and a planning and behavior module 206. The computer(s) 202 interface with a control module 210, which in some embodiments is the vehicle 10, in other embodiments is a hardware mock-up of the sensors and actuators of the vehicle 10, and in other embodiments is a computer based model of the sensors and actuators of the vehicle 10. As such, the control module 210 may reside in the computer(s) 202 or outside thereof. The computer(s) 202 may also include or be associated with one or more databases 212, 214 that may reside in the computer(s) 202 or may be in communication therewith. In the current embodiment, the database 212 receives and stores, in a curated fashion, real-world data from the fleet of autonomous vehicles, such as the vehicle 10. The validation system 200 may be wirelessly networked with the vehicle 10 for transfer of data through the communication device 48, or data may be transferred through any other available method. The database 212 may also contain data virtually generated in a simulated environment for a model of the vehicle 10.

As further detailed below, the sensing and perception module 204 of the validation system 200 may generate perturbations of the data collected from the vehicle 10 and/or data generated virtually, to increase the number of scenarios in the database 212. The collected data is converted to a common representation format in the sensing and perception module 204, and may be further manipulated into a preferred format for further use in the planning and behavior module 206. Algorithms may be evaluated using the test database 214 through scenarios that may entail customized behaviors. As further detailed below, the planning and behavior module 206 of the validation system 200 may generate additional perturbations using the data in test database 214 to increase the number of scenarios in storage. The planning and behavior module 206 uses the scenarios to evaluate control features such as algorithms and software that control the vehicle 10 or its elements. In the planning and behavior module 206, algorithm/software performance is evaluated such as relative to metrics, and is evaluated in the control module 210 through control an autonomous vehicle, or a mock-up or a model thereof. Through the validation system 200, a faster-than-real-time evaluation of control algorithms/software is accomplished by parallel and distributed implementations of the algorithms/software. The real-world data is supplemented with simulation generated data, and by creating perturbations. Use of real-world data increases the realistic nature of event scenarios used to evaluate performance. The validation system 200 may also be used in evaluating hardware in the control module 210.

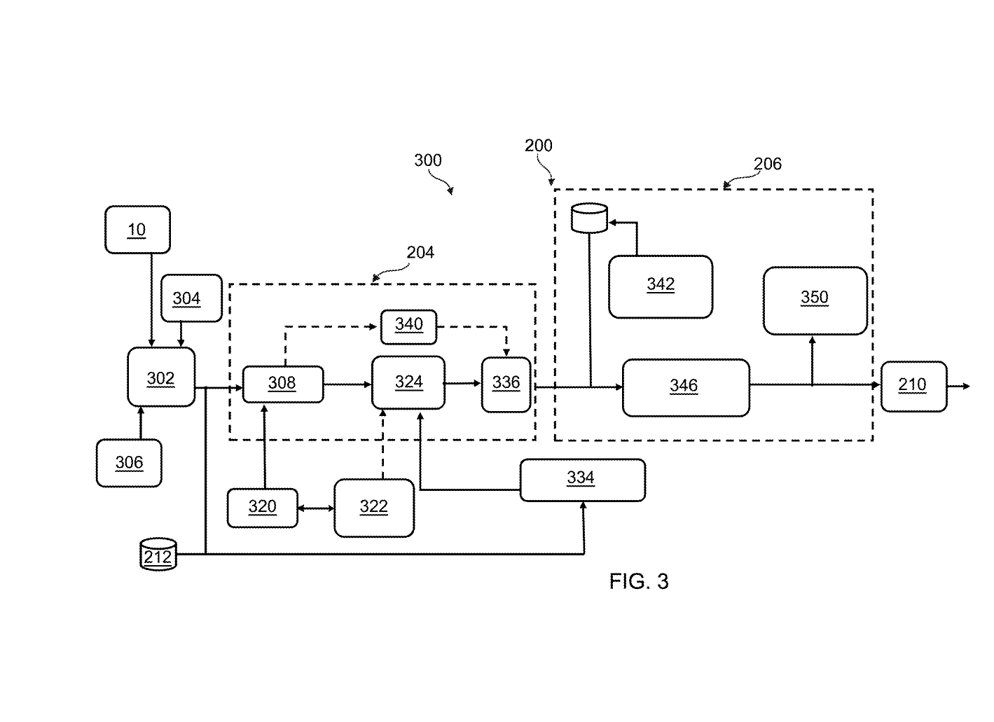

Referring to FIG. 3 along with FIG. 1, an exemplary architecture for a system 300 for end-to-end autonomous vehicle development and validation is illustrated. The system 300 is in many aspects consistent with the validation system 200 of FIG. 2, with additional detail. Data is collected by fleet of vehicles including the vehicle 10, such as from the sensor system 28 including the sensing devices 40a-40n that sense observable conditions of the exterior environment and/or the interior environment of the autonomous vehicle 10 and its operation. This includes raw data from sensors 40a-40n on the environment of the vehicle 10, such as from cameras, LIDAR, RADAR, GPS, vehicle-to-vehicle/human/infrastructure, and other sensors, along with data from onboard sensors 40a-40n that monitor the status of the vehicle including actuation of the actuators 42, such as speed sensors, steering angle sensors, brake apply sensors, an inertial measurement unit, and other sensors. The data is captured by a logging system of the on-board processor 44 and held in the data storage device 32 and/or the computer readable storage device or media 46. The sensor data is extracted 302 from the vehicle 10 such as through a wireless communication connection, a temporary wired connection, or via a readable media. As noted above, the communication system 36 may be used for this purpose. The data represents real-world data on the whole state of information about the vehicle 10. Data may also be extracted 302 from infrastructure based sensors 304 and other mobile source sensors 306. For example, sensors 304 may be leveraged from existing infrastructure sensors such as cameras, and/or may be deployed to capture specific scene situations such as intersections, U-turn locations, merge points, curves, bottlenecks, and others, to supplement data collected by the vehicles 10. In addition, sensors 306 may be deployed on other mobile platforms such as aircraft to obtain global views of traffic patterns, long term behaviors, and other information. The data, from the sources 10, 304, and/or 306, is held in curated form in the database 212 and serves as inputs to the sensing and perception module 204.

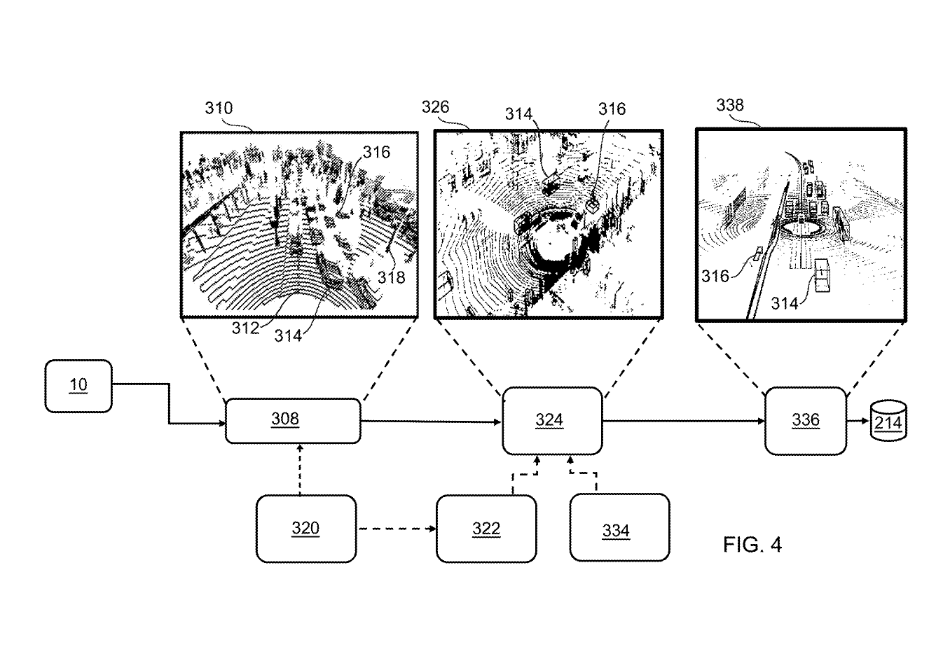

The data from database 212 is synthesized and processed in fusion module 308 to represent the presence, location, classification, and/or path of objects and features of the environment of the vehicle 10 and of the scenes captured by sensors 304, 306. The fusion module 308 incorporates information from the multiple sensors in a register type synchronized form. For example, as shown in FIG. 4, data from the vehicle 10 may be used to reproduce a scene from the perspective of the vehicle as depicted in image 310. For example, a roadway 312, other vehicles 314, objects 316, and signs 318 may be represented. Data may also be included from sensor model emulator 320 using a simulated virtual sensor set modeling the sensors 40a-40n. This may include a model of the vehicle 10 with all sensors 40a-40n. Generation of data for various scenarios may be scripted or manually prompted to generate synthetic data. The sensor model emulator 320 may run in the validation system 200 or in another computer or computers. Scenarios may be created with a number of other actors including roadway variations, pedestrians, other vehicles and other objects. Data from the sensor model emulator 320 may be stored in the database 212 or may be supplied directly to the fusion module 308, where it is fused along with the real-world data. The sensor model emulator coordinates with a virtual world renderer 322, which creates 3-dimensional representations of roadways and objects using the virtually generated data from the sensor model emulator 320. For example, environmental aspects of the virtual world may include infrastructure details such as traffic signals, traffic marks, traffic signs, and others. In addition, object aspects of the virtual world may include the identification of the object and whether it moves or is stationary, along with a timestamp, location, size, speed, acceleration, heading, trajectory, surface reflectivity and material properties. Event information may be included, such as lane changes, speed changes, stops, turns, and others.

The sensing and perception module 204 includes a converter module 324 that converts the fused sensor data from fusion module 308 into a common representation form of the environment using the results from the virtual world renderer 322, in which both the real vehicle 10 and the simulated vehicle represented by the sensor model emulator 320 are operated. For example, in the current embodiment the converter module 324 converts the data to voxel data (e.g. RGB, XYZ), for a common representation form of both real-world data from the vehicle(s) 10 and virtual data from the sensor model emulator 320. Each voxel contains color and/or intensity (RGB) and depth XYZ information. The converted voxel data as depicted in image 326 is represented in a common perspective showing roadways 312, vehicles 314, and objects 316. The voxel data is represented in a global reference frame and may be converted by any suitable method such as photogrammetry. The conversion includes a transformation of scene location to a common dimensional model (coordinate system XYZ), a common color space (color model RGB), and temporal alignment. In this example, the vehicles 314 and objects 316 are depicted in boundary boxes as shown in image 326. The 3D voxel data is segmented into voxels containing vehicles, pedestrians, traffic lights, signs, lanes, and other objects and features which are amenable to being perturbed and manipulated in the 3D space. Perturbations of the real-world data, such as from the vehicle 10, are created in perturbation module 334. Perturbation module 334 may run in the validation system 200 or in other computer(s). Perturbations may include variations on the data, creating additional scenarios in the location and/or movement of vehicles 314 and objects 316, such as by moving a neighboring vehicle 314 to various other locations. Perturbations may also include the introduction/addition of new vehicles 314, objects 316 and other entities to the data that may have realistic surface reflectivity and other material properties to resemble vehicles, objects and other entities captured in the real-world. More specifically, examples include the delay in movement of an object by a period of time, copying the behavior of an object from real-world scene A to real-world scene B, and so on. The creation of perturbations is prompted to increase the number and variation of scenarios in the dataset available to the system 300. For example, the amount of data may be increased by an order of magnitude. Accordingly, limitations in collecting data in the real world are overcome by creating new data as variations of the real-world data. For example, scenarios that have not arisen, such as the appearance of another actor, sign placements, traffic signal operation, and others may be created for use in evaluations. Because the perturbations are based on real-world data, they have a high level of validity and are realistic. The results are that virtual and real elements are fused. For example, real-world perception elements are present in a virtual world. An example includes using real-world road environment aspects with virtual sensor outputs. By creating perturbations from real-world data, the challenges of making realistic behavior in a purely virtual world are avoided. In other embodiments, perturbations of the virtual data from sensor model emulator 320 may also be created.

The voxel data from the converter module 324 is then transformed to 3-dimensional (3D) object data in the generator module 336. As shown by image 338 of FIG. 4, the 3D object data may be used to generate custom frames for scenarios and may appear more real, and provides a near-actual representation of the environment within which evaluated algorithms/software will perform in the system 300. For example, the location of other vehicles 314 and objects 316, along with their orientation and movements relative to the host vehicle are depicted with high accuracy. The 3D object data includes both the real-word and virtually generated data, and is delivered to the planning and behavior module 206. Specifically, the 3D object data is stored in test database 214. In other embodiments, other mechanisms and algorithms that transform fused sensor data into 3D object data may be included or alternatively used as indicated by transformation module 340, shown in FIG. 3. For example, a mechanism may be used such as a typical perception system used in an autonomous vehicle that identifies vehicles, roadways, objects, pedestrians, signs and signals, along with their attributes.

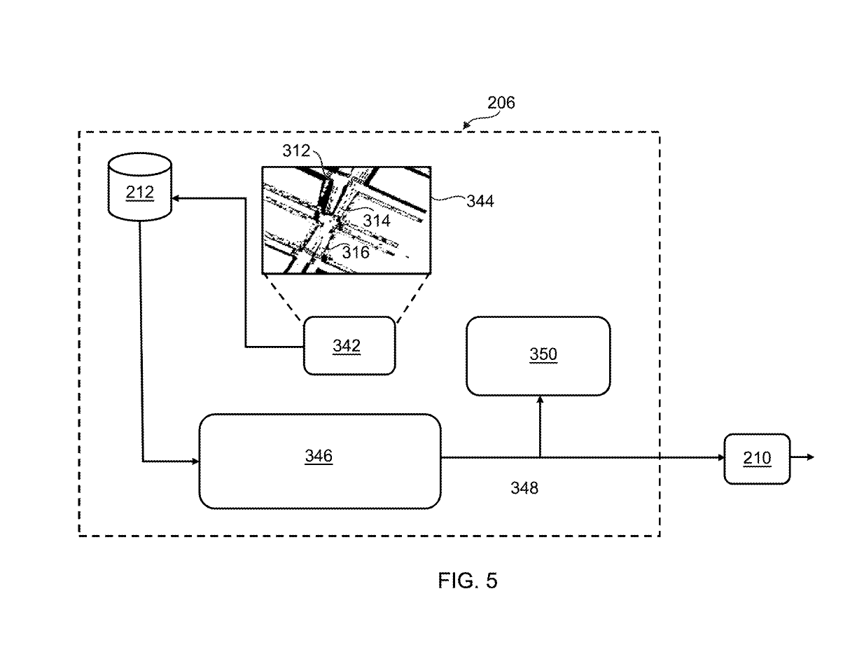

In general, the planning and behavior module 206 uses the 3D object data, including information about other vehicles and their movement with respect to the host vehicle and plans ahead, simulating operation of the host vehicle in a multitude of situations to evaluate the performance of algorithms for controlling the vehicle. With reference to FIGS. 3 and 5, included in the planning and behavior module 206 is a perturbation module 342 that generates perturbations of the data in test database 214 that is received from the sensing and perception module 204. In particular, the real-world data is perturbated to increase the variations in the data such as to create additional traffic situations, including rare occurrences (e.g. a rapidly decelerating vehicle). As depicted in image 344, new traffic patterns are created, which may include additional vehicles 314, additional objects 316, changes in roadways 312, and movement variation. The scene is actuated with real and custom behaviors, including those that create challenges for the host vehicle to respond to and navigate. For example, perturbations may be created with other vehicles or objects intersecting the trajectory of the host vehicle creating near collisions, and other challenging events.

With the perturbations added to the test database 214, a control feature such as an algorithm/software for controlling some aspect of the vehicle 10 is loaded in testing module 346. The algorithm/software uses the sensor based inputs from test database 214, processes the inputs and creates outputs such as commands for the function it is intended to control. The outputs 348 are delivered to an evaluation engine 350 and to the control module 210. At the evaluation engine 350, the outputs are evaluated for robust, safe and comfortable operation, including in relation to scoring metrics. An algorithm/software being evaluated uses the data inputs to determine a course of action and delivers outputs. For example, with an algorithm that controls steering angle such as a pathfinding algorithm, the lateral acceleration developed during a simulated maneuver may be compared to target values such as 0.5 g, and scored based on the acceleration noted from the test. At the control module 210, the outputs are executed in actual or simulated control of the vehicle 10. In some examples, the control module 210 may be the vehicle 10. In other embodiments, the control module 210 may be a hardware mock-up of the relevant portions of the vehicle 10, such as the sensors 28, 40 and the actuators 42. Hardware-in-the-loop (HIL) simulation testing may be used to test the hardware and algorithms/software of computer-based controls. It may also be used to evaluate the hardware. In additional embodiments, the control module 210 may be a virtual model of the vehicle 10. Model-in-the-loop (MIL) or software-in -the-loop (SIL) testing has benefits such as allowing early evaluation during the development phase even before hardware is available. From the control module 210, the response of the vehicle 10 in executing the commands of the algorithm/software under evaluation are observable. The control module 210 may be within the planning and behavior model 206, or may be in a linked computer separate therefrom. The planning and behavior module 206 is useful in both algorithm/software development and algorithm/software validation. For example, an algorithm may be evaluated, changes may be made to it and then it may be evaluated again, including through a number of iterations, so that improvements may be made in the algorithm during its development. Also, in development, an algorithm may be evaluated under many different scenarios. In addition, a developed algorithm may be evaluated for validation purposes. Through the system 300, autonomous vehicle control and operation may be evaluated in thousands of scenarios over the equivalent of billions of road miles in a reasonable time frame.

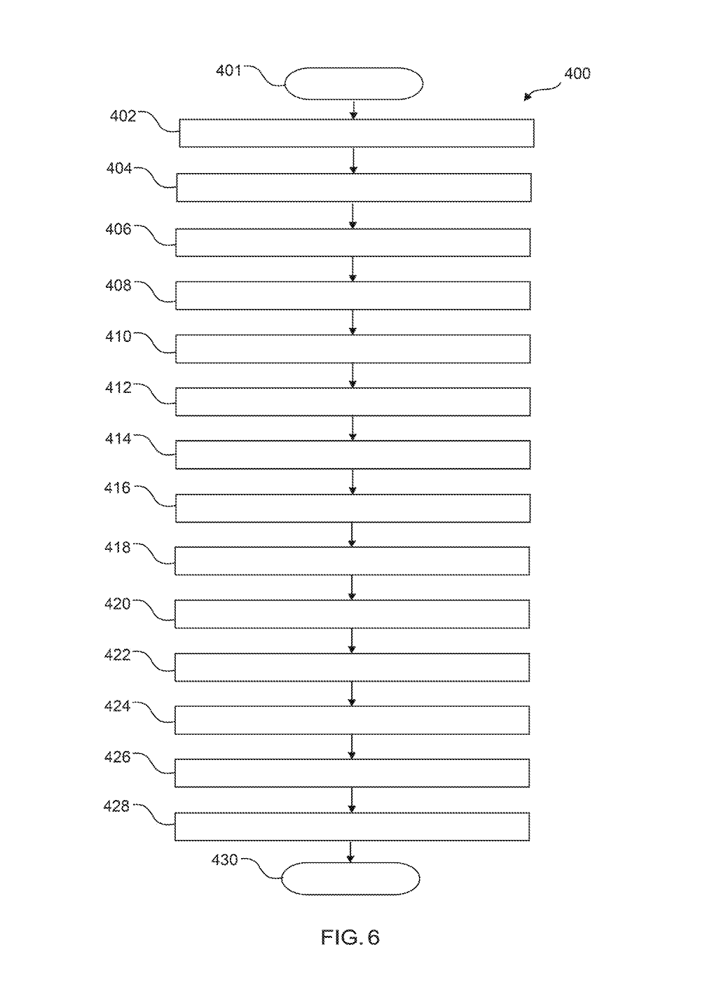

Referring to FIG. 6, a process 400 using the system 300 is illustrated in flowchart form. Process 400 begins 401 and proceeds with data collection 402 from real-world sources including autonomous vehicles such as vehicle 10, infrastructure sources 304 and other mobile platform sources 306. The collected data is stored at store data 404 in curated form such as in test database 214. Virtual/synthetic data generation 406 is used to supplement the data collection 402. In this embodiment, the data is fused at data fusion 408 and converted to voxel data 410. The process 400 generates perturbations 412 from the data collection 402 to expand the data set with variations that are realistic, and the generated perturbation data is added to the fused data at 414. 3D object data is generated 416 from the voxel data and is stored 418, such as in test database 214. The test database 214 is supplemented with perturbations generated 420 in perturbation module 342 such as with additional traffic scenarios. An algorithm/software is loaded 422 to testing module 346 and the algorithm/software is executed 424 using data from the test database 214. Command outputs from the execution 424 are evaluated 426 such as at evaluation engine 350. The evaluation may include scoring metrics and may evaluate a number of factors. Command outputs from the execution 424 are also executed in a vehicle environment, with actual or modeled hardware, such as at the control module 210 at control of hardware/model 428, and the process 400 ends 430.

Through the foregoing system 200/300 and process 400, a combination of real-world and virtual data is used to rapidly simulate the operation of an autonomous vehicle or its systems over a very large number and types of scenarios and distance. Perturbation is used at various stages to multiply the data available for testing purposes and to create more eventful use cases. The same system 200/300 framework may be used for both development and validation purposes. While at least one exemplary embodiment has been presented in the foregoing detailed description, it should be appreciated that a vast number of variations exist. It should be also noted that faster-than-real-time evaluation of autonomous vehicle perception, planning behavior and control algorithms/software is accomplished by one or more processors in the computer(s) using this vast data feeding at higher frame-rates (e.g., >30 frames per second) to state of the art parallel and/or distributed computing clusters and/or supercomputers. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
collecting, by an autonomous vehicle having a sensor system and actuators, a real-world sensor data set;
fusing, by a fusion module of a computer system, the real-world sensor data set;
converting, by a converter module, the fused real-world sensor data set to a common representation data set form;
generating perturbations, by a perturbation module, from the converted real-world sensor data set;
generating, by a generator module, a 3-dimensional object data set from the common representation data set form of the real-world sensor data set; and
using the 3-dimensional object data set to evaluate control features of the autonomous vehicle.

2. The method of claim 1, further comprising:
generating, by a sensor model emulator, a virtual sensor data set;
fusing, by the fusion module, the virtual sensor data set;
converting, by the converter module, the fused virtual sensor data set to the common representation data set form; and
generating, by the generator module, the 3-dimensional object data set from the common representation data set form of the virtual sensor data set.

3. The method of claim 1, wherein converting to a common representation data set form comprises converting the real-world sensor data set to a voxel data set.

4. The method of claim 3, further comprising:
generating, by a sensor model emulator, a virtual sensor data set;
fusing, by the fusion module, the virtual sensor data set: and
converting the virtual sensor data set to the voxel data set.

5. The method of claim 1, further comprising:
storing the 3-dimensional data set in a test database; and
generating perturbations of the 3-dimensional data set to create traffic scenarios.

6. The method of claim 5, wherein generating perturbations of the 3-dimensional data set includes adding additional vehicles to the traffic scenarios.

7. The method of claim 5, further comprising:
evaluating, by a planning and behavior module, an algorithm by using the 3-dimensional database in executing the algorithm.

8. A method comprising:
collecting, by an autonomous vehicle having a sensor system and actuators, a real-world sensor data set;
generating, by a generator module, a 3-dimensional object data set from the real-world sensor data set;
generating, by a perturbation module of a planning and behavior module, perturbations of the 3-dimensional data set to create traffic scenarios; and
executing, by the planning and behavior module, a control feature by using the 3-dimensional database including the perturbations in executing the control feature.

9. The method of claim 8, further comprising executing command outputs from the control feature in a control module that simulates the autonomous vehicle.

10. The method of claim 8, further comprising executing command outputs from the control feature in a control module, that includes the actuators of the autonomous vehicle, to evaluate their operation.

11. The method of claim 8, further comprising evaluating, by an evaluation engine, command outputs from the control feature in relation to scoring metrics

12. The method of claim 11, further comprising executing the command outputs in a control module that simulates the autonomous vehicle.

13. The method of claim 11, further comprising executing the command outputs in a control module that includes the actuators of the autonomous vehicle to evaluate their operation.

14. The method of claim 8, further comprising:
fusing, by a fusion module of a computer system, the real-world sensor data set;
converting, by a converter module, the fused real-world sensor data set to a common representation data set form; and
generating second perturbations, by a second perturbation module, from the converted real-world sensor data set.

15. The method of claim 8 wherein the control feature comprises an algorithm.

16. A system comprising:
a real-world sensor data set generated by an autonomous vehicle having sensors;
a virtual-world data set generated by a virtual-world model and high-fidelity sensor models;
a sensing and perception module configured to:
generate, in a first perturbation module, first perturbations of the real-world sensor data set;
generate, in a generator module, a 3-dimensional object data set from the real-world sensor data set; and
a planning and behavior module configured to:
generate, in a second perturbation module, second perturbations of the 3-dimensional object data set;
test, in a testing module, a control feature using the 3-dimensional object data set including the second perturbations; and
execute, in a control module, command outputs from the control feature.

17. The system of claim 16, wherein the control module includes actuators of the autonomous vehicle that are responsive to the command outputs.

18. The system of claim 16, wherein the sensor and perception module is configured to:
fuse, by a fusion module of a computer system, the real-world sensor data set; and
convert, by a converter module, the fused real-world sensor data set to a common representation data set form, prior to generating the 3-dimensional object data set.

19. The system of claim 16, further comprising:
a sensor model emulator configured to generate a virtual sensor data set from a sensor model;
wherein the planning and behavior module is configured to evaluate, in an evaluation engine, the command outputs for performance in relation to scoring metrics; and
wherein the real-world sensor data set includes data from infrastructure based sensors and mobile platform based sensors.

20. The system of claim 16, further comprising at least one processor configured to process data at frame-rates in excess of thirty frames per second, sufficient to evaluate at least millions of vehicle miles for development and validation.
